(19) United States
(12) Patent Application Publication
(10) Pub. No.: US 2015/0018264 A1
(43) Pub. Date: Jan. 15, 2015

(54) LAUNDRY DETERGENT COMPOSITION

(71) Applicant: The Procter & Gamble Company, Cincinnati, OH (US)

(72) Inventors: Nigel Patrick SOMERVILLE ROBERTS, Newcastle upon Tyne (GB); Collin URE, Tyne and Wear (GB); Zoe Rosa TRISTON, Co Durham (GB); Carly PICKERING, Tyne and Wear (GB); Victor Stuart REID, Newcastle upon Tyne (GB); Alan Thomas BROOKER, Newcastle upon Tyne (GB); Rui SHEN, Beijing (CN)

(21) Appl. No.: 14/319,296

(22) Filed: Jun. 30, 2014

(30) Foreign Application Priority Data
Jul. 11, 2013 (CN) PCT/CN2013/079191

(51) Int. Cl. C11D 3/34

(52) U.S. Cl. CPC C11D 3/3463
USPC 510/346

(57) ABSTRACT

A laundry detergent composition comprising;
(a) less than 50% by weight of the laundry detergent composition of carbonate;
(b) a first particle wherein the first particle is an agglomerate comprising;
   wherein the first particle has a Mettler moisture content of between 1 and 3%; and
(c) a second particle wherein the second particle comprises;
wherein the ratio of linear alkylbenzene sulphonate to carbonate in the laundry detergent composition is from 3:1 to 1:1.5.

### FIELD OF THE INVENTION

The present invention relates to a granular laundry detergent composition.

### BACKGROUND OF THE INVENTION

Granular laundry detergent compositions comprise active materials such as anionic surfactants which provide benefits such as fabric cleaning. Often, in the case of granular detergent compositions, these active materials are added to a carrier material to form ‘an active particle’ which is added to the composition.

A common fabric cleaning active ingredient is linear alkylbenzene sulphonic acid (HLAS), and its neutralized form, linear alkylbenzene sulphonate (LAS). Active particles are often made comprising HLAS and carbonate. As well as serving as a carrier, the carbonate also provides a role in neutralizing the HLAS to LAS. This neutralization is essential, as HLAS is a highly viscous material and can cause the granular laundry detergent composition to stick together, or ‘cake’. This ‘caking’ negatively impacts the flowability of the composition which can cause problems in use. LAS is a crystalline material which is more free flowing so aiding the flowability of the granular laundry detergent composition.

Another fabric cleaning ingredient is alkoxylated alkyl sulphate (AES). Like HLAS, AES is also very ‘sticky’.

However, although the presence of carbonate has positive benefits, it also results in a wash liquor having a high pH. This high pH is harsh on the skin, especially for fabric hand-wash consumers. Furthermore, the high pH can negatively impact some cleaning actives.

Therefore, there is a need in the art for granular laundry detergent compositions that comprise LAS, AES and low carbonate levels, yet still maintain excellent flowability.

The Inventors surprisingly found that by carefully and specifically controlling the levels and ratios of carbonate, LAS, AES and water in the granular laundry detergent composition, it was possible to lower the carbonate levels yet still maintain excellent flowability.

### SUMMARY OF THE INVENTION

A laundry detergent composition comprising;
(a) less than 50% by weight of the laundry detergent composition of carbonate;
(b) a first particle wherein the first particle is an agglomerate comprising;
   i) from 10% to 35% by weight of the first particle of linear alkylbenzene sulphonate;
   ii) less than 10% by weight of the first particle of an alkoxylated alkyl sulphate;
   iii) less than 35% by weight of the first particle of carbonate material;
   iv) 30% or higher by weight of the first particle of a carrier material;
   wherein the first particle has a Mettler moisture content of between 1 and 3% and wherein the Mettler moisture content is a measure of the percentage decrease in the weight of a 2 g sample of the first agglomerate which has been heated at a temperature of 160° C. for a period of 5 minutes; and
(c) a second particle wherein the second particle comprises;
   i) at least 10% by weight of the second particle of an alkoxylated alkyl sulphate;
   ii) less than 10% by weight of the second particle of linear alkylbenzene sulphonate;
   iii) between 1% and 40% by weight of the second particle of a carrier material;
wherein the ratio of linear alkylbenzene sulphonate to carbonate in the laundry detergent composition is from 3:1 to 1:1.5.

### DETAILED DESCRIPTION OF THE INVENTION

### Laundry Detergent Composition

The present invention is to a laundry detergent composition comprising a first particle, wherein the first particle is an agglomerate particle and a second particle. The second particle may be an agglomerate, an extrudate or a spray-dried particle. Preferably, the second particle is an agglomerate.

The laundry detergent composition may comprise between 20 and 80% by weight of the first particle and between 2 and 80% by weight of the second particle.

The laundry detergent composition may comprise between 5 wt % and 90 wt %, preferably between 15 wt % and 80 wt %, more preferably between 20 wt % and 75 wt % of the first particle.

The laundry detergent composition may comprise between 3 wt % and 80 wt %, preferably between 5 wt % and 70 wt %, more preferably between 10 wt % and 6% of the second particle.

The ratio of linear alkylbenzene sulphonate to carbonate in the laundry detergent composition is from 3:1 to 1:1.5 or even from 2:1 to 1:1.

The first particle, the second particle, or both particles may comprise a polymer. The first and second particles may each comprise a different polymer or may both comprise the same polymer.

The ratio of linear alkylbenzene sulphonate to alkoxylated alkyl sulphate may be from 13:1 to 4:1.

The laundry detergent composition can be a granular laundry detergent composition. It is preferred that the laundry detergent composition is in granular free-flowing form.

The laundry detergent composition is suitable for any laundry detergent application, for example: laundry, including automatic washing machine laundering and hand laundering, and even bleach and laundry additives.

The laundry detergent composition can be a fully formulated detergent product, such as a fully formulated laundry detergent product, or it can be combined with other particles to form a fully formulated detergent product, such as a fully formulated laundry detergent product. The first and second particles may be present with other particles such as: enzyme particles; perfume particles including agglomerates or extrudates of perfume microcapsules, and perfume encapsulates such as starch encapsulated perfume accord particles; surfactant particles, such as non-ionic detersive surfactant particles including agglomerates or extrudates, anionic detersive surfactant particles including agglomerates and extrudates, and cationic detersive surfactant particles including agglomerates and extrudates; polymer particles including soil release polymer particles, cellulosic polymer particles; buffer particles including carbonate salt and/or silicate salt particles, preferably a particle comprising carbonate salt and silicate salt such as a sodium carbonate and sodium silicate co-particle, and particles and sodium bicarbonate; other spray-dried particles; fluorescent whitening particles; aesthetic particles such as coloured noodles or needles or lamellae particles; bleaching particles such as percarbonate particles, especially coated percarbonate particles, including carbonate and/or sulphate coated percarbonate, silicate coated percarbonate, borosilicate coated percarbonate, sodium perborate coated percarbonate; bleach catalyst particles, such as transition metal catalyst bleach particles, and imine bleach boosting particles; performed per acid particles; hueing dye particles; and any mixture thereof.

It may also be especially preferred for the laundry detergent composition to comprise low levels, or even be essentially free, of builder. By essentially free of it is typically meant herein to mean: “comprises no deliberately added”. In a preferred embodiment, the laundry detergent composition comprises no builder.

The laundry detergent composition typically comprises from 0 wt % to 7 wt %, preferably from lwt % to 5 wt %, and preferably from 2 wt % to 3 wt % water.

The laundry detergent composition may comprise other detergent ingredients detailed below.

The laundry detergent composition may comprise an enzyme. The enzyme is described in more detail below.

The laundry detergent composition may comprise a bulking agent. Without wishing to be bound by theory, a bulking agent is a material used in a laundry detergent composition which is separate to the agglomerate particle and serves a purpose other than providing a fabric care benefit. For example, a bulking agent may help maintain flowability of the laundry detergent composition, and help achieve a desired bulk density of the laundry detergent composition.

Those skilled in the art will recognize suitable bulking agents. The bulking agent is described in more detail below.

The laundry detergent composition is typically flowable, typically having a cake strength of from 0 N to 20 N, preferably from 0 N to 15 N, more preferably from 0 N to 10 N, most preferably from 0 N to 5 N. The method to determine the cake strength is described in more detail elsewhere in the description.

### First Particle

The composition of the present invention comprises a first particle, wherein the first particle is an agglomerate, and wherein the particle comprises;
i) from 10% to 35% by weight of the agglomerate particle of linear alkybenzene sulphonate;
ii) less than 10% by weight of the first particle of alkoxylated alkyl sulphate;
iii) less than 35% by weight of the agglomerate particle of carbonate material;
iv) 30% or higher by weight of the agglomerate particle of a process aid;
   wherein the first particle has a Mettler moisture content of between 1 and 3% and wherein the Mettler moisture content is a measure of the percentage decrease in the weight of a 2 g sample of the first particle which has been heated at a temperature of 160° C. for a period of 5 minutes.

The first particle comprises from 10% to 35%, or even from 10% to 30% or even from 10% to 20% by weight of the agglomerate particle of linear alkylbenzene sulphonate. In the present context, by “linear alkylbenzene sulphonate” we herein mean the fully neutralized salt form, or a partially neutralized form which comprises both the fully neutralized salt and also the linear alkylbenzene sulphonic acid form, or a mixture thereof. Alternatively, the linear alkybenzene sulphonate comprises just the neutralized salt form. Linear alkylbenzene sulphonate is described in more detail below.

The first particle comprises less than 10% by weight of the first particle of an alkoxylated alkyl sulphate. The first particle may comprise between 0% and 20%, or from 1% to 18% or from 5% to 15% by weight of the first particle of an alkoxylated alkyl sulphate. Without wishing to be bound by theory, the presence of an alkoxylated alkyl sulphate provides for improved fabric cleaning as compared to the presence of just linear alkylbenzene sulphonate. If alkoxylated alkyl sulphate is present, then preferably the ratio of linear alkylbenzene sulphonate to alkoxylated alkyl sulphate is from 13:1 to 4:1. Alkoxylated alkyl sulphate is described in more detail below.

The first particle comprises less than 35% by weight of the first particle of carbonate material. The first particle may comprise from 0% to 35%, or even 1% to 30% or even 2% to 25%, or even 5% to 15% by weight of the first particle of carbonate material. Carbonate material is described in more detail below.

The first particle comprises 30% or higher by weight of the first particle of a carrier material. Suitable carrier materials are well known to those skilled in the art. In the context of the present invention the carrier material is not the same material as the carbonate material present in the first particle. Suitable carrier materials in the first particle can include zeolite, sulphate, an alkali metal chloride, silicate, citric, silica or a mixture thereof.

The first particle may comprise a polymer. Suitable polymers are described in more detail below.

The first particle has a Mettler moisture content of between 1 and 3%. In the context of the present invention, the Mettler moisture content is a measure of the percentage decrease in the weight of a 2 g sample of the first particles which has been heated at a temperature of 160° C. for a period of 5 minutes.

Without wishing to be bound by theory, the Inventors surprisingly found that the specific control of the levels and ratios of carbonate, LAS and water in the first particle allowed lower overall carbonate levels in the first particle and the laundry detergent composition yet still resulted in excellent flowability of the laundry detergent composition.

### Second Particle

The composition of the present invention comprises a second particle wherein the second particle comprises;
i) at least 10% by weight of the second particle of an alkoxylated alkyl sulphate;
ii) less than 10% by weight of the second particle of linear alkylbenzene sulphonate;
iii) between 1% and 40% by weight of the second particle of a carrier material.
   The second particle comprises at least 10% by weight of the second particle particle of an alkoxylated alkyl sulphate. The second particle may comprise between 10% and 80%, or from 12% to 75% or from 15% to 70% by weight of the second particle of an alkoxylated alkyl sulphate. Without wishing to be bound by theory, the presence of an alkoxylated alkyl sulphate provides for improved fabric cleaning as compared to the presence of just linear alkylbenzene sulphonate. Alkoxylated alkyl sulphate is described in more detail below.

The second particle comprises less than 10% by weight of the second particle of linear alkylbenzene sulphonate. In the present context, by “linear alkylbenzene sulphonate” we herein mean the fully neutralized salt form, or a partially neutralized form which comprises both the fully neutralized salt and also the linear alkylbenzene sulphonic acid form, or a mixture thereof. Alternatively, the linear alkybenzene sulphonate comprises just the neutralized salt form. Linear alkylbenzene sulphonate is described in more detail below.

The second particle comprises between 1% and 40% by weight of the second particle of a carrier material. Suitable carrier materials are well known to those skilled in the art. In the context of the present invention the carrier material is not carbonate present in the second particle. Suitable carrier materials in the second particle can include zeolite, sulphate, an alkali metal chloride, silicate, citric, silica or a mixture thereof. Preferably the carrier material in the second particle is silica. The second particle may comprise from 5% to 35%, or even from 5% to 30% by weight of the second particle of a carrier material.

The second particle may comprise less than 30% by weight of the second particle of carbonate material, preferably less then 20 wt %, more preferably less then 10 wt % carbonate material. Carbonate material is described in more detail below.

The second particle may comprise a polymer. Suitable polymers are described in more detail below.

### Linear Alkylbenzene Sulphonate (LAS)

The LAS present in the first particle, the second particle, or both particles can be any suitable LAS, preferably a C₁₀₋₁₃ LAS. Suitable alkyl benzene sulphonate (LAS) is obtainable, or even obtained, by sulphonating commercially available linear alkyl benzene (LAB); suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. Another suitable anionic detersive surfactant is alkyl benzene sulphonate that is obtained by DETAL catalyzed process, although other synthesis routes, such as HF, may also be suitable.

In the present context, by “linear alkylbenzene sulphonate” we here mean the fully neutralized salt form, or a partially neutralized form which comprises both the fully neutralized salt and also the linear alkylbenzene sulphonic acid form, or a mixture thereof. Any suitable means can be used to neutralize the HLAS to form LAS. Full or partial neutralization can be achieved prior to addition of the HLAS/LAS to being formulated into the agglomerate particle. Alternatively, full or partial neutralization can be achieved in-situ during the formation of the agglomerate particle. Alternatively, a combination of pre-neutralization and in-situ neutralization may occur during the formation of the agglomerate particle. Alternatively, the linear alkybenzene sulphonate comprises just the neutralized salt form.

Without being bound by theory, it is believed that the careful balance of the LAS, carbonate and water levels in the first particle allows for sufficient neutralization of the LAS without an excess of either water or carbonate. If there is too little water or carbonate then insufficient neutralization occurs and this results in the agglomerate particle being too ‘sticky’ due to the high levels of HLAS. If the water level is too high, then this may result in sufficient neutralization but too much moisture in the agglomerate particle resulting in caking of the laundry detergent composition. If too much carbonate is present, this may result in sufficient neutralization, but will result in the wash liquor being to alkali and so not providing the skin mildness benefit.

### Alkoxylated Alkyl Sulphate

The alkoxylated alkyl sulphate present in the first particle, the second particle or both particles can be any suitable alkoxylated alkyl sulphate. Preferably, the alkoxylated alkyl sulphate is a linear or branched, substituted or unsubstituted C₁₂₋₁₈ alkyloxylated alkyl sulphate having an average degree of alkoxylation of from 1 to 30, preferably from 1 to 10. Preferably, the alkoxylated alkyl alkoxylated sulphate is a linear or branched, substituted or unsubstituted C₁₂₋₁₈ alkyl ethoxylated sulphate having an average degree of ethoxylation of from 1 to 10. Most preferably, the alkoxylated alkyl sulphate is a linear unsubstituted C₁₂₋₁₈ alkyl ethoxylated sulphate having an average degree of ethoxylation of from 3 to 7.

The alkoxylated alkyl sulphate may also increase the LAS activity by making the LAS less likely to precipitate out of solution in the presence of free calcium cations. The specific ratio of LAS to alkoxylated alkyl sulphate according to the present invention gives optimal greasy soil cleaning performance combined with a good hardness tolerancy profile. It may also provide a good sudsing profile.

Suitable alkoxylated alkyl sulphates are: Texapan LEST™ by Cognis; Cosmacol AES™ by Sasol; BES151™ by Stephan; Empicol ESC70/U™; and mixtures thereof.

### Carbonate Material

The carbonate material in the first particle, the second particle or both particles and also if added separately to the laundry detergent composition can be any suitable carbonate material. A preferred carbonate material is sodium carbonate and/or sodium bicarbonate. Alternatively, the carbonate material may be potassium carbonate and/or potassium bicarbonate. A highly preferred carbonate material is sodium carbonate.

Alternatively, the carbonate material may be burkeite, sequicarbonate or a crystal growth modified carbonate such as habit modified carbonate or crystal growth modified burkeite.

The carbonate material, or at least part thereof, is typically in particulate form, typically having a weight average particle size in the range of from 200 to 500 micrometers. However, it may be preferred for the carbonate material, or at least part thereof, to be in micronised particulate form, typically having a weight average particle size in the range of from 4 to 40 micrometers.

### Polymer

The first particle, the second particle, or both particles independently may comprise a polymer. Suitable polymers include carboxylate polymers, such as polyacrylates, and acrylate/maleic co-polymers and other functionalized polymers such as styrene acrylates. Preferably, the carboxylate polymer is an acrylate/maleic copolymer having an average molecular weight of about 2,000 to about 100,000 and a ratio of acrylate to maleate segments of from about 30:1 to about 1:1.

One suitable polymer is an amphiphilic graft polymer (AGP). Suitable AGPs are obtainable by grafting a polyalkylene oxide of number average molecular weight from about 2,000 to about 100,000 with vinyl acetate, which may be partially saponified, in a weight ratio of polyalkylene oxide to vinyl acetate of about 1:0.2 to about 1:10. The vinyl acetate may, for example, be saponified to an extent of up to 15%. The polyalkylene oxide may contain units of ethylene oxide, propylene oxide and/or butylene oxide. Selected embodiments comprise ethylene oxide.

In some embodiments the polyalkylene oxide has a number average molecular weight of from about 4,000 to about 50,000, and the weight ratio of polyalkylene oxide to vinyl acetate is from about 1:0.5 to about 1:6. A material within this definition, based on polyethylene oxide of molecular weight 6,000 (equivalent to 136 ethylene oxide units), containing approximately 3 parts by weight of vinyl acetate units per 1 part by weight of polyethylene oxide, and having itself a molecular weight of about 24,000, is commercially available from BASF as Sokalan HP22.

Suitable AGPs may be present in the detergent composition at weight percentages of from about 0% to about 5%, preferably from about above 0% to about 4%, or from about 0.5% to about 2%. In some embodiments, the AGP is present at greater than about 1.5 wt %. The AGPs are found to provide excellent hydrophobic soil suspension even in the presence of cationic coacervating polymers.

Preferred AGPs are based on water-soluble polyalkylene oxides as a graft base and side chains formed by polymerization of a vinyl ester component. These polymers having an average of less than or equal to one graft site per 50 alkylene oxide units and mean molar masses (Mw) of from about 3000 to about 100,000.

Another suitable polymer is polyethylene oxide, preferably substituted or un-substituted.

Another suitable polymer is cellulosic polymer, preferably selected from alkyl cellulose, alkyl alkoxyalkyl cellulose, carboxylalkyl cellulose, alkyl carboxyalkyl, more preferably selected from carboxymethyl cellulose (CMC) including blocky CMC, methyl cellulose, methyl hydroxyethyl cellulose, methyl carboxymethyl cellulose, and mixtures thereof.

Other suitable polymers are soil release polymers. Suitable polymers include polyester soil release polymers. Other suitable polymers include terephthalate polymers, polyurethanes, and mixtures thereof. The soil release polymers, such as terephthalate and polyurethane polymers can be hydrophobically modified, for example to give additional benefits such as sudsing.

Other suitable polymers include polyamines, preferably polyethylene imine polymers, preferably having ethylene oxide and/or propylene oxide functionalized blocks

Other suitable polymers include synthetic amino containing amphoteric/and/or zwitterionic polymers, such as those derived from hexamethylene diamine

Another suitable polymer is a polymer that can be co-micellized by surfactants, such as the AGP described in more detail above.

Other suitable polymers include silicone, including amino-functionalised silicone.

Suitable polymers can include clay and soil removal/anti-redeposition agents being co-polymers comprising:
(i) from 50 to less than 98 wt % structural units derived from one or more monomers comprising carboxyl groups; (ii) from 1 to less than 49 wt % structural units derived from one or more monomers comprising sulfonate moieties; and (iii) from 1 to 49 wt % structural units derived from one or more types of monomers selected from ether bond-containing monomers represented by formulas (I) and (II):

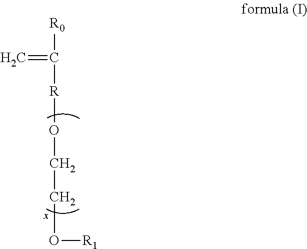

wherein in formula (I), R₀ represents a hydrogen atom or CH₃ group, R represents a CH₂ group, CH₂CH₂ group or single bond, X represents a number 0-5 provided X represents a number 1-5 when R is a single bond, and R₁ is a hydrogen atom or C₁ to C₂₀ organic group;

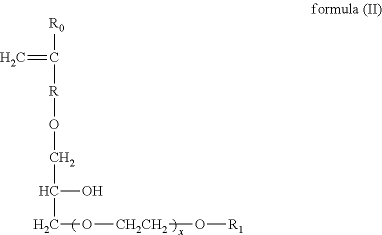

in formula (II), R₀ represents a hydrogen atom or CH₃ group, R represents a CH₂ group, CH₂CH₂ group or single bond, X represents a number 0-5, and R₁ is a hydrogen atom or C₁ to C₂₀ organic group.

Other suitable polymers include polysaccharide polymers such as celluloses, starches, lignins, hemicellulose, and mixtures thereof.

Other suitable polymers include cationic polymers, such as deposition aid polymers, such as cationically modified cellulose such as cationic hydroxy ethylene cellulose, cationic guar gum, cationic starch, cationic acrylamides and mixtures thereof.

Mixtures of any of the above described polymers can be used herein.

### Enzymes

Enzymes can be included in the formulations herein for a wide variety of fabric laundering purposes, including removal of protein-based, carbohydrate-based, or triglyceride-based stains, for example, and for the prevention of refugee dye transfer, and for fabric restoration. The enzymes to be incorporated include proteases, amylases, carbohydrases, cellulases, laccases, lipases, bleaching enzymes such as oxidases and peroxidases, proteases, pectate lyases, mannanases, and mixtures thereof. Other types of enzymes may also be included. They may be of any suitable origin, such as vegetable, animal, bacterial, fungal and yeast origin. However, their choice is governed by several factors such as pH-activity and/or stability optima, thermostability, stability versus active detergents, builders and so on. In this respect bacterial or fungal enzymes are preferred, such as bacterial amylases and proteases, and fungal cellulases.

Enzymes are normally incorporated at levels sufficient to provide up to about 5 mg by weight, more typically about 0.01 mg to about 3 mg, of active enzyme per gram of the composition. Stated otherwise, the compositions herein will typically comprise from about 0.001% to about 5%, preferably 0.01%-1% by weight of a commercial enzyme preparation.

Suitable proteases include metalloproteases and/or serine proteases, such as subtilisins (EC 3.4.21.62). Suitable proteases include those of animal, vegetable or microbial origin. In one aspect, such suitable protease may be of microbial origin. The suitable proteases include chemically or genetically modified mutants of the aforementioned suitable proteases. In one aspect, the suitable protease may be a serine protease, such as an alkaline microbial protease or/and a trypsin-type protease. Amylases include, for example, amylases described in British Patent Specification No. 1,296,839 (Novo), RAPIDASE, International Bio-Synthetics, Inc. and TERMAMYL, Novo Industries.

The cellulase usable in the present invention include both bacterial or fungal cellulase. Preferably, they will have a pH optimum of between 5 and 9.5. Suitable cellulases are fungal cellulases produced from Humicola insolens and Humicola strain DSM1800 or a cellulase 212-producing fungus belonging to the genus Aeromonas, and cellulase extracted from the hepatopancreas of a marine mollusk (Dolabella Auricula Solander).

Suitable lipase enzymes for detergent usage include those produced by microorganisms of the Pseudomonas group, such as Pseudomonas stutzeri ATCC 19.154. This lipase is available from Amano Pharmaceutical Co. Ltd., Nagoya, Japan, under the trade name Lipase P “Amano,” hereinafter referred to as “Amano-P.” Other commercial lipases include Amano-CES, lipases ex Chromobacter viscosum, e.g. Chromobacter viscosum var. lipolyticum NRRLB 3673, commercially available from Toyo Jozo Co., Tagata, Japan; and further Chromobacter viscosum lipases from U.S. Biochemical Corp., U.S.A. and Disoynth Co., The Netherlands, and lipases ex Pseudomonas gladioli. The LIPOLASE enzyme derived from Humicola lanuginose and commercially available from Novo is a preferred lipase for use herein.

Peroxidase enzymes are used in combination with oxygen sources, e.g., percarbonate, perborate, persulfate, hydrogen peroxide, etc. They are used for “solution bleaching,” i.e. to prevent transfer of dyes or pigments removed from substrates during wash operations to other substrates in the wash solution. Peroxidase enzymes are known in the art, and include, for example, horseradish peroxidase, ligninase, and haloperoxidase such as chloro- and bromo-peroxidase.

### Bulking Agent

The bulking agent present in the laundry detergent composition may be any suitable bulking agent known to those skilled in the art. The bulking agent may comprise a material selected from carbonate, silicate, sulphate, silica, an alkali metal chloride, burkeite or a mixture thereof. It is preferred that the laundry detergent composition comprises less than 50 wt %, preferably less than 40 wt % carbonate material.

Alternatively, the bulking agent may comprise a spray dried particle, wherein the spray-dried particle comprises at least 45 wt % sulphate and has a bulk density of from 350 g/l to 700 g/l.

### Fabric Hueing Agent

The laundry detergent composition may comprise a fabric hueing agent (sometimes referred to as shading, bluing or whitening agents). Typically the hueing agent provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and mixtures thereof. Suitable fabric hueing agents include dyes, dye-clay conjugates, and organic and inorganic pigments. Suitable dyes include small molecule dyes and polymeric dyes. Suitable small molecule dyes include small molecule dyes selected from the group consisting of dyes falling into the Colour Index (C.I.) classifications of Acid, Direct, Basic, Reactive or hydrolysed Reactive, Solvent or Disperse dyes for example that are classified as Blue, Violet, Red, Green or Black, and provide the desired shade either alone or in combination. In another aspect, suitable small molecule dyes include small molecule dyes selected from the group consisting of Colour Index (Society of Dyers and Colourists, Bradford, UK) numbers Direct Violet dyes such as 9, 35, 48, 51, 66, and 99, Direct Blue dyes such as 1, 71, 80 and 279, Acid Red dyes such as 17, 73, 52, 88 and 150, Acid Violet dyes such as 15, 17, 24, 43, 49 and 50, Acid Blue dyes such as 15, 17, 25, 29, 40, 45, 75, 80, 83, 90 and 113, Acid Black dyes such as 1, Basic Violet dyes such as 1, 3, 4, 10 and 35, Basic Blue dyes such as 3, 16, 22, 47, 66, 75 and 159, Disperse or Solvent dyes such as those described in US 2008/034511 A1 or U.S. Pat. No. 8,268,016 B2, or dyes as disclosed in U.S. Pat. No. 7,208,459 B2, and mixtures thereof. In another aspect, suitable small molecule dyes include small molecule dyes selected from the group consisting of C. I. numbers Acid Violet 17, Direct Blue 71, Direct Violet 51, Direct Blue 1, Acid Red 88, Acid Red 150, Acid Blue 29, Acid Blue 113 or mixtures thereof.

Preferred dyes include dye polymers, wherein a dye group is bound to a polymeric group, optionally via a linking group. Suitable polymeric groups include (1) alkoxylated polyethyleneimine (for example as disclosed in WO2012119859), (2) polyvinyl alcohol (for example as disclosed in WO2012130492), or (3) diamine derivative of an alkylene oxide capped polyethylene glycol (for example as disclosed in WO2012126665, especially FIG. 24), or polyalkoxylated alcohol, for example as described in WO2011/011799, WO2012/054058, WO2012/166699 or WO2012/166768. One preferred class of dye polymers is obtainable by reacting a blue or violet dye containing an NH2 group with a polymer to form a covalent bond via the reacted NH2 group of the blue or violet dye and the dye polymer has an average of from 0 to 30, preferably 2 to 20, most preferably 2 to 15 repeating same units. In a preferred embodiment the monomeric units are selected from alkylene oxides, preferably ethylene oxides.

Typically dye polymers will be in the form of a mixture of dye polymers in which there is a mixture of molecules having a distribution of number of monomer groups in the polymer chains, such as the mixture directly produced by the appropriate organic synthesis route, for example in the case of alkylene oxide polymers, the result of an alkoxylation reaction. Such dye polymers are typically blue or violet in colour, to give to the cloth a hue angle of 230 to 345, more preferably 250 to 330, most preferably 270 to 300. In the synthesis of dye polymers unbound blue or violet organic dyes may be present in a mixture with the final dye-polymer product. The chromophore of the blue or violet dye is preferably selected from the group consisting of: azo; anthraquinone; phthalocyanine; triphendioxazine; and, triphenylmethane. In one aspect the dye polymer is obtainable by reacting a dye containing an NH[2] group with a polymer or suitable monomer that forms a polymer in situ. Preferably the NH[2] is covalently bound to an aromatic ring of the dye. Unbound dye is formed when the dye does not react with polymer. Preferred dyes containing —NH[2] groups for such reactions are selected from: acid violet 1; acid violet 3; acid violet 6; acid violet 11; acid violet 13; acid violet 14; acid violet 19; acid violet 20; acid violet 36; acid violet 36:1; acid violet 41; acid violet 42; acid violet 43; acid violet 50; acid violet 51; acid violet 63; acid violet 48; acid blue 25; acid blue 40; acid blue 40:1; acid blue 41; acid blue 45; acid blue 47; acid blue 49; acid blue 51; acid blue 53; acid blue 56; acid blue 61; acid blue 61:1; acid blue 62; acid blue 69; acid blue 78; acid blue 81:1; acid blue 92; acid blue 96; acid blue 108; acid blue 111; acid blue 215; acid blue 230; acid blue 277; acid blue 344; acid blue 117; acid blue 124; acid blue 129; acid blue 129:1; acid blue 138; acid blue 145; direct violet 99; direct violet 5; direct violet 72; direct violet 16; direct violet 78; direct violet 77; direct violet 83; food black 2; direct blue 33; direct blue 41; direct blue 22; direct blue 71; direct blue 72; direct blue 74; direct blue 75; direct blue 82; direct blue 96; direct blue 110; direct blue 111; direct blue 120; direct blue 120:1; direct blue 121; direct blue 122; direct blue 123; direct blue 124; direct blue 126; direct blue 127; direct blue 128; direct blue 129; direct blue 130; direct blue 132; direct blue 133; direct blue 135; direct blue 138; direct blue 140; direct blue 145; direct blue 148; direct blue 149; direct blue 159; direct blue 162; direct blue 163; food black 2; food black 1 wherein the acid amide group is replaced by NH[2]; Basic Violet 2; Basic Violet 5; Basic Violet 12; Basic Violet 14; Basic Violet 8; Basic Blue 12; Basic Blue 16; Basic Blue 17; Basic Blue 47; Basic Blue 99; disperse blue 1; disperse blue 5; disperse blue 6; disperse blue 9; disperse blue 11; disperse blue 19; disperse blue 20; disperse blue 28; disperse blue 40; disperse blue 56; disperse blue 60; disperse blue 81; disperse blue 83; disperse blue 87; disperse blue 104; disperse blue 118; disperse violet 1; disperse violet 4, disperse violet 8, disperse violet 17, disperse violet 26; disperse violet 28; solvent violet 26; solvent blue 12; solvent blue 13; solvent blue 18; solvent blue 68. Further preferred dyes are selected from mono-azo dyes which contain a phenyl group directly attached to the azo group, wherein the phenyl group has an NH[2] groups covalent bound to it. For example a mono-azo thiophene dye. The polymer chain may be selected from polyalkylene oxides. The polymer chain and/or the dye chromophore group may optionally carry anionic or cationic groups. Examples of polyoxyalkylene oxide chains include ethylene oxide, propylene oxide, glycidol oxide, butylene oxide and mixtures thereof.

Suitable polymeric dyes include polymeric dyes selected from the group consisting of polymers containing covalently bound (sometimes referred to as conjugated) chromogens, (dye-polymer conjugates), for example polymers with chromogens co-polymerized into the backbone of the polymer and mixtures thereof. Polymeric dyes include those described in WO2011/98355, US 2012/225803 A1, US 2012/090102 A1, U.S. Pat. No. 7,686,892 B2, and WO2010/142503.

In another aspect, suitable polymeric dyes include polymeric dyes selected from the group consisting of fabric-substantive colorants sold under the name of Liquitint® (Milliken, Spartanburg, S.C., USA), dye-polymer conjugates formed from at least one reactive dye and a polymer selected from the group consisting of polymers comprising a moiety selected from the group consisting of a hydroxyl moiety, a primary amine moiety, a secondary amine moiety, a thiol moiety and mixtures thereof. In still another aspect, suitable polymeric dyes include polymeric dyes selected from the group consisting of Liquitint® Violet CT, carboxymethyl cellulose (CMC) covalently bound to a reactive blue, reactive violet or reactive red dye such as CMC conjugated with C.I. Reactive Blue 19, sold by Megazyme, Wicklow, Ireland under the product name AZO-CM-CELLULOSE, product code S-ACMC, alkoxylated triphenyl-methane polymeric colourants, alkoxylated thiophene polymeric colourants, and mixtures thereof.

Preferred hueing dyes include the whitening agents found in WO 08/87497 A1, WO2011/011799 and US 2012/129752 A1. Preferred hueing agents for use in the present invention may be the preferred dyes disclosed in these references, including those selected from Examples 1-42 in Table 5 of WO2011/011799. Other preferred dyes are disclosed in U.S. Pat. No. 8,138,222B2, especially claim 1 of U.S. Pat. No. 8,138,222B2. Other preferred dyes are disclosed in U.S. Pat. No. 7,909,890 B2.

Suitable dye clay conjugates include dye clay conjugates selected from the group comprising at least one cationic/basic dye and a smectite clay, and mixtures thereof. In another aspect, suitable dye clay conjugates include dye clay conjugates selected from the group consisting of one cationic/basic dye selected from the group consisting of C.I. Basic Yellow 1 through 108, C.I. Basic Orange 1 through 69, C.I. Basic Red 1 through 118, C.I. Basic Violet 1 through 51, C.I. Basic Blue 1 through 164, C.I. Basic Green 1 through 14, C.I. Basic Brown 1 through 23, CI Basic Black 1 through 11, and a clay selected from the group consisting of Montmorillonite clay, Hectorite clay, Saponite clay and mixtures thereof. In still another aspect, suitable dye clay conjugates include dye clay conjugates selected from the group consisting of: Montmorillonite Basic Blue B7 C.I. 42595 conjugate, Montmorillonite Basic Blue B9 C.I. 52015 conjugate, Montmorillonite Basic Violet V3 C.I. 42555 conjugate, Montmorillonite Basic Green G1 C.I. 42040 conjugate, Montmorillonite Basic Red R1 C.I. 45160 conjugate, Montmorillonite C.I. Basic Black 2 conjugate, Hectorite Basic Blue B7 C.I. 42595 conjugate, Hectorite Basic Blue B9 C.I. 52015 conjugate, Hectorite Basic Violet V3 C.I. 42555 conjugate, Hectorite Basic Green G1 C.I. 42040 conjugate, Hectorite Basic Red R1 C.I. 45160 conjugate, Hectorite C.I. Basic Black 2 conjugate, Saponite Basic Blue B7 C.I. 42595 conjugate, Saponite Basic Blue B9 C.I. 52015 conjugate, Saponite Basic Violet V3 C.I. 42555 conjugate, Saponite Basic Green G1 C.I. 42040 conjugate, Saponite Basic Red R1 C.I. 45160 conjugate, Saponite C.I. Basic Black 2 conjugate and mixtures thereof.

Suitable pigments include pigments selected from the group consisting of flavanthrone, indanthrone, chlorinated indanthrone containing from 1 to 4 chlorine atoms, pyranthrone, dichloropyranthrone, monobromodichloropyranthrone, dibromodichloropyranthrone, tetrabromopyranthrone, perylene-3,4,9,10-tetracarboxylic acid diimide, wherein the imide groups may be unsubstituted or substituted by C1-C3-alkyl or a phenyl or heterocyclic radical, and wherein the phenyl and heterocyclic radicals may additionally carry substituents which do not confer solubility in water, anthrapyrimidinecarboxylic acid amides, violanthrone, isoviolanthrone, dioxazine pigments, copper phthalocyanine which may contain up to 2 chlorine atoms per molecule, polychloro-copper phthalocyanine or polybromochloro-copper phthalocyanine containing up to 14 bromine atoms per molecule and mixtures thereof.

In another aspect, suitable pigments include pigments selected from the group consisting of Ultramarine Blue (C.I. Pigment Blue 29), Ultramarine Violet (C.I. Pigment Violet 15) and mixtures thereof.

The hueing agent may having the following structure:

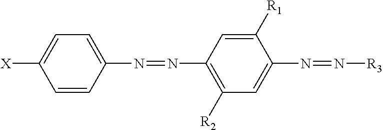

wherein:
R₁ and R₂ are independently selected from the group consisting of: H; alkyl; alkoxy; alkyleneoxy; alkyl capped alkyleneoxy; urea; and amido;
   R₃ is a substituted aryl group;
X is a substituted group comprising sulfonamide moiety and optionally an alkyl and/or aryl moiety, and wherein the substituent group comprises at least one alkyleneoxy chain that comprises at least four alkyleneoxy moieties.
   The hueing agent may comprise
a) a Zn—, Ca—, Mg—, Na—, K—, Al, Si—, Ti—, Ge—, Ga—, Zr—, In— or Sn— phthalocyanine compound of formula (1)

(PC)-L-(D) (1)
to which at least one mono-azo dyestuff is attached through a covalent bonding via a linking group L wherein
   PC is a metal-containing phthalocyanine ring system;
   D is the radical of a mono-azo dyestuff; and
L is a group

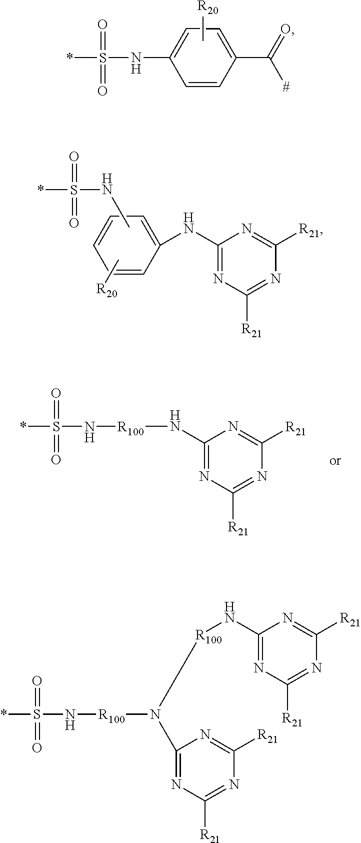

wherein
R₂₀ is hydrogen, C₁-C₈alkyl, C₁-C₈alkoxy or halogen;
R₂₁ is independently D, hydrogen, OH, Cl or F, with the proviso that at least one is D;
R₁₀₀ is C₁-C₈alkylene
* is the point of attachment of PC;
# is the point of attachment of the dye.

The aforementioned fabric hueing agents can be used in combination (any mixture of fabric hueing agents can be used).

### Dye Transfer Inhibitor Polymer

The laundry detergent composition may comprise dye transfer inhibitor (DTI) polymers. Suitable DTIs include polyamine N-oxide polymers, copolymers of N-vinylpyrrolidone and N-vinylimidazole, polyvinylpyrrolidone polymers, polyvinyloxazolidones and polyvinylimidazoles or mixtures thereof. The DTI polymers discussed above are well known in the art and commercially available, for example PVP-K15 and K30 (Ashland), Sokalan HP165, HP50, HP53, HP59, HP56K, HP56, HP66 (BASF), Chromabond S-400, S403E and S-100 (Ashland), and Polyquart FDI (Cognis).

### Zeolite Builder

Suitable zeolite builder includes include zeolite A, zeolite P and zeolite MAP. Especially suitable is zeolite 4A.

### Phosphate Builder

A typical phosphate builder is sodium tri-polyphosphate.

### Other Detergent Ingredients

The composition typically comprises other detergent ingredients. Suitable detergent ingredients include: transition metal catalysts; imine bleach boosters; source of peroxygen such as percarbonate salts and/or perborate salts, preferred is sodium percarbonate, the source of peroxygen is preferably at least partially coated, preferably completely coated, by a coating ingredient such as a carbonate salt, a sulphate salt, a silicate salt, borosilicate, or mixtures, including mixed salts, thereof; bleach activator such as tetraacetyl ethylene diamine, oxybenzene sulphonate bleach activators such as nonanoyl oxybenzene sulphonate, caprolactam bleach activators, imide bleach activators such as N-nonanoyl-N-methyl acetamide, preformed peracids such as N,N-pthaloylamino peroxycaproic acid, nonylamido peroxyadipic acid or dibenzoyl peroxide; suds suppressing systems such as silicone based suds suppressors; brighteners; hueing agents; photobleach; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as oligomers produced by the condensation of imidazole and epichlorhydrin; soil dispersants and soil anti-redeposition aids such as alkoxylated polyamines and ethoxylated ethyleneimine polymers; anti-redeposition components such as polyesters and/or terephthalate polymers, polyethylene glycol including polyethylene glycol substituted with vinyl alcohol and/or vinyl acetate pendant groups; perfumes such as perfume microcapsules, polymer assisted perfume delivery systems including Schiff base perfume/polymer complexes, starch encapsulated perfume accords; soap rings; aesthetic particles including coloured noodles and/or needles; dyes; fillers such as sodium sulphate, although it may be preferred for the composition to be substantially free of fillers; carbonate salt including sodium carbonate and/or sodium bicarbonate; silicate salt such as sodium silicate, including 1.6 R and 2.0 R sodium silicate, or sodium metasilicate; co-polyesters of di-carboxylic acids and diols; cellulosic polymers such as methyl cellulose, carboxymethyl cellulose, hydroxyethoxycellulose, or other alkyl or alkylalkoxy cellulose, and hydrophobically modified cellulose; carboxylic acid and/or salts thereof, including citric acid and/or sodium citrate; and any combination thereof.

### Method of Laundering Fabric

The method of laundering fabric typically comprises the step of contacting the composition to water to form a wash liquor, and laundering fabric in said wash liquor, wherein typically the wash liquor has a temperature of above 0° C. to 90° C., or to 60° C., or to 40° C., or to 30° C., or to 20° C., or to 10° C., or even to 8° C. The fabric may be contacted to the water prior to, or after, or simultaneous with, contacting the laundry detergent composition with water. The composition can be used in pre-treatment applications.

Typically, the wash liquor is formed by contacting the laundry detergent to water in such an amount so that the concentration of laundry detergent composition in the wash liquor is from above 0 g/l to 5 g/l, or from 1 g/l, and to 4.5 g/l, or to 4.0 g/l, or to 3.5 g/l, or to 3.0 g/l, or to 2.5 g/l, or even to 2.0 g/l, or even to 1.5 g/l.

The method of laundering fabric may be carried out in a top-loading or front-loading automatic washing machine, or can be used in a hand-wash laundry application. In these applications, the wash liquor formed and concentration of laundry detergent composition in the wash liquor is that of the main wash cycle. Any input of water during any optional rinsing step(s) is not included when determining the volume of the wash liquor.

The wash liquor may comprise 40 litres or less of water, or 30 litres or less, or 20 litres or less, or 10 litres or less, or 8 litres or less, or even 6 litres or less of water. The wash liquor may comprise from above 0 to 15 litres, or from 2 litres, and to 12 litres, or even to 8 litres of water.

Typically from 0.01 kg to 2 kg of fabric per litre of wash liquor is dosed into said wash liquor. Typically from 0.01 kg, or from 0.05 kg, or from 0.07 kg, or from 0.10 kg, or from 0.15 kg, or from 0.20 kg, or from 0.25 kg fabric per litre of wash liquor is dosed into said wash liquor.

Optionally, 50 g or less, or 45 g or less, or 40 g or less, or 35 g or less, or 30 g or less, or 25 g or less, or 20 g or less, or even 15 g or less, or even 10 g or less of the composition is contacted to water to form the wash liquor.

### Method of Making

The first particle of the present invention may be made using any suitable mixing device. Agglomeration may be carried out in a mechanical mixer, such as paddle mixer, or a CB lodige, KM lodige, Schugi mixer. In a preferred embodiment all components of the agglomerate particle are added to the mechanical mixer and are agglomerated together.

The second particle may be made using the same method as the first particle. Alternatively, the second particle may be made by extruding or spray-drying.

The first and second particles may be mixed with other components to make the final laundry detergent composition. Components may also be sprayed on the first and second particles or onto the final laundry detergent composition. Such spray-on materials can include perfumes and/or surfactants.

A preferred process for making the first particle is a low shear mixing process. Any suitable mixing device can be used. The mixing device may be a low shear paddle mixer. Preferably the mixer is not a fluidized bed mixing device. The residence time for the mixing operation may be 10 minutes or less.

### Method for Measuring Cake Strength

A smooth plastic cylinder of internal diameter 6.35 cm and length 15.9 cm is supported on a suitable base plate. A 0.65 cm hole is drilled through the cylinder with the centre of the hole being 9.2 cm from the end opposite the base plate.

A metal pin is inserted through the hole and a smooth plastic sleeve of internal diameter 6.35 cm and length 15.25 cm is placed around the inner cylinder such that the sleeve can move freely up and down the cylinder and comes to rest on the metal pin. The space inside the sleeve is then filled (without tapping or excessive vibration) with the spray-dried powder such that the spray-dried powder is level with the top of the sleeve. A lid is placed on top of the sleeve and a 5 kg weight placed on the lid. The pin is then pulled out and the spray-dried powder is allowed to compact for 2 minutes. After 2 minutes the weight is removed, the sleeve is lowered to expose the powder cake with the lid remaining on top of the powder.

A metal probe is then lowered at 54 cm/min such that it contacts the centre of the lid and breaks the cake. The maximum force required to break the cake is recorded and is the result of the test. A cake strength of 0 N refers to the situation where no cake is formed.

### Method of Measuring Mettler Moisture Content

The first particle of the present invention has a Mettler moisture content of between 1 and 3% and wherein the Mettler moisture content is a measure of the percentage decrease in the weight of a 2 g sample of the agglomerate which has been heated at a temperature of 160° C. for a period of 5 minutes.

An exemplary apparatus for measuring the Mettler moisture content is the Mettler Toledo HB43-S (Halogen) using a 6mm sample pan size. The apparatus was operated as per the manufacturing instructions using the infra red lamp.

### EXAMPLES

The following is an example of a composition as according to the present invention.

TABLE 1

| | % wt in final | % in first | % in second |
|---|---|---|---|
| Raw Material | composition | particle | particle |
| Linear | 9.7 | 22.5 | — |
| alkylbenzene | | | |
| sulphonate | | | |
| Alkoxylated | 1.6 | — | 55 |
| alkyl sulphate | | | |
| (Av EO = 1) | | | |
| Polymer | 0.8 | 1.87 | — |
| Enzyme | 0.4 | — | — |
| zeolite | 1.9 | — | — |
| Na2So4 | 23.1 | 51.0 | 40 |
| Ground Na2So4 | 5.0 | — | — |
| Salt | 46.0 | — | — |
| Na2Co3 | 9.8 | 22.8 | — |
| Perfume | 0.2 | — | — |
| Brightener | 0.1 | — | — |
| Misc | 1.4 | 1.83 | 5 |
| Total | 100 | 100 | 100 |
| % in final | | 43% | 2.9% |
| composition | | | |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to the term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A laundry detergent composition comprising;
(a) less than about 50% by weight of the laundry detergent composition of carbonate;
(b) a first particle wherein the first particle is an agglomerate comprising;
i) from about 10% to about 35% by weight of the first particle of linear alkylbenzene sulphonate;
ii) less than about 10% by weight of the first particle of an alkoxylated alkyl sulphate;
iii) less than about 35% by weight of the first particle of carbonate material;
iv) about 30% or higher by weight of the first particle of a carrier material;
wherein the first particle has a Mettler moisture content of between about 1 and about 3% and wherein the Mettler moisture content is a measure of the percentage decrease in the weight of about a 2 g sample of the first agglomerate which has been heated at a temperature of about 160° C. for a period of about 5 minutes; and
(c) a second particle wherein the second particle comprises;
i) at least about 10% by weight of the second particle of an alkoxylated alkyl sulphate;
ii) less than about 10% by weight of the second particle of linear alkylbenzene sulphonate;
iii) between about 1% and about 40% by weight of the second particle of a carrier material;
wherein the ratio of linear alkylbenzene sulphonate to carbonate in the laundry detergent composition is from about 3:1 to about 1:1.5.

2. The laundry detergent composition according to claim 1 wherein the ratio of linear alkylbenzene sulphonate to alkoxylated alkyl sulphate is from about 13:1 to about 4:1.

3. The laundry detergent composition according to claim 1 comprising between about 20 and about 80% by weight of the first particle and between about 2 and about 80% by weight of the second particle.

4. The laundry detergent composition according to claim 1 wherein the carrier material in the first particle comprises zeolite, sulphate, an alkali metal chloride, silicate, citric, silica or a mixture thereof.

5. The laundry detergent composition according to claim 1, wherein the carrier material in the second particle comprises zeolite, sulphate, an alkali metal chloride, silicate, citric, silica or a mixture thereof.

6. The laundry detergent composition according to claim 1, wherein the first particle, the second particle or both independently comprise a polymer preferably, the polymer being independently selected from the group comprising:
a) polycarboxylate homopolymers, preferably polyacrylate homopolymers;
b) polycarboxylate co-polymers, preferably acrylic acid/maleic acid co-polymers;
c) co-polymers comprising:
(i) from about 50 to less than about 98 wt % structural units derived from one or more monomers comprising carboxyl groups;
(ii) from about 1 to less than about 49 wt % structural units derived from one or more monomers comprising sulfonate moieties; and
(iii) from about 1 to about 49 wt % structural units derived from one or more types of monomers selected from ether bond-containing monomers represented by formulas (I) and (II): 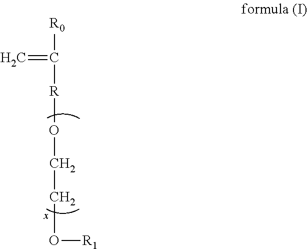
wherein in formula (I), R₀ represents a hydrogen atom or CH₃ group, R represents a CH₂ group, CH₂CH₂ group or single bond, X represents a number 0-5 provided X represents a number 1-5 when R is a single bond, and R₁ is a hydrogen atom or C₁ to C₂₀ organic group; 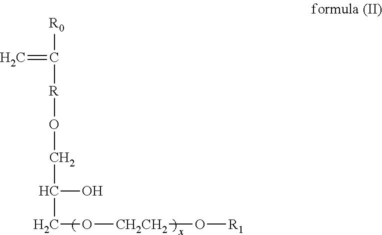
in formula (II), R₀ represents a hydrogen atom or CH₃ group, R represents a CH₂ group, CH₂CH₂ group or single bond, X represents a number 0-5, and R₁ is a hydrogen atom or C₁ to C₂₀ organic group;
d) any combination thereof.

7. The laundry detergent composition according to claim 1 comprising an enzyme.

8. The laundry detergent composition according to claim 1 comprising a bulking agent, wherein the bulking agent is separate from the first and second particles.

9. The laundry detergent composition according to claim 8, wherein the bulking agent comprises a material selected from silicate, sulphate, silica, an alkali metal chloride, burkeite or a mixture thereof.

10. The laundry detergent composition according to claim 9, wherein the bulking agent comprises a spray dried particle, wherein the spray-dried particle comprises at least about 45 wt % sulphate and has a bulk density of from about 350 g/l to about 700 g/l.
